(19) United States
(12) Patent Application Publication
(10) Pub. No.: US 2011/0176803 A1
(43) Pub. Date: Jul. 21, 2011

(54) SYSTEM AND METHOD FOR INDOOR POSITIONING USING LED LIGHTING

(75) Inventors: Ki-Uk Song, Suwon-si (KR); Dae-Kwang Jung, Suwon-si (KR); Jeong-Seok Choi, Yongin-si (KR); Hong-Seok Shin, Yongin-si (KR); Kyung-Woo Lee, Yongin-si (KR); Sung-Bum Park, Suwon-si (KR); Jae-Gwang Shim, Seoul (KR)

(73) Assignee: Samsung Electronics Co., Ltd., Suwon-si (KR)

(21) Appl. No.: 13/008,455

(22) Filed: Jan. 18, 2011

(30) Foreign Application Priority Data
Jan. 15, 2010 (KR) 10-2010-0003958

(51) Int. Cl. H04B 10/02

(52) U.S. Cl. 398/43

(57) ABSTRACT

A system for performing indoor positioning using a Light Emitting Diode (LED) lighting unit is provided. The system includes the LED lighting unit for determining whether transmission packet data exists in a frame to be transmitted, modulating the transmission packet data in accordance with a predetermined method in order to maintain a uniform brightness of the LED lighting unit when the transmission packet data exists, and transmitting the frame including the modulated transmission packet data. The system also includes a mobile terminal for receiving the frame, demodulating the modulated transmission packet data to determine the transmission packet data, and performing indoor positioning by using the demodulated transmission packet data and information included in the frame.

### PRIORITY

This application claims priority under 35 U.S.C. §119(a) to an application entitled “System and Method for Indoor Positioning Using LED Lightening” filed in the Korean Intellectual Property Office on Jan. 15, 2010, and assigned Serial No. 10-2010-0003958, the contents of which are incorporated herein by reference.

### BACKGROUND OF THE INVENTION

1. Field of the Invention

The present invention relates generally to a positioning service, and more particularly, to a system and a method for indoor positioning using lighting.

2. Description of the Related Art

As the luminous efficiency of Light Emitting Diodes (LEDs) has improved, and their price has decreased. The LED has recently entered general lighting markets, which include fluorescent lamps and incandescent electric lamps, as well as special lighting markets, which include portable devices, displays, cars, traffic lights, billboards and the like. Various factors have caused an increase in interest in optical wireless communication technologies that are complementary to Radio Frequency (RF) technologies. These factors include the exhaustion of RF bandwidth frequency, interference possibilities between several wireless communication technologies, an increasing demand for communication security, the advent of an ultra-high speed ubiquitous communication environment based on 4G wireless technologies, etc.

Visible light communication for transferring information using visible light is safe, has a wide usage band, and can be freely used without limitations. Furthermore, visible light communication is advantageous in that it is possible to accurately know a reception range of information because an arrival position of light or an advancing direction of light can be seen. Thus, the communication is advantageous in that it is reliable in view of security, and can be driven by less power in view of power consumption. Accordingly, visible light communication can be applied to hospitals and airplanes in which the use of a RF is restricted, and can also be used in providing additional information using an electronic display board.

Moreover, visible light communication can be more efficiently used in combination with another communication system using other wired/wireless communication media. Specifically, research on a power line communication based on a power line or a visible light communication system for providing information by using lighting within a building in combination with wireless LAN is being conducted.

Meanwhile, mobile communication terminals, such as cellular phones and smart phones, which can be carried by a user, have recently incorporated various convenient functions, such as a message transmitting/receiving function, a wireless internet function, a schedule managing function, and a navigation function, and a general voice communication function.

A navigation function using a Global Positioning System (GPS) provides route information on a user's present position and the user's required destination. In general, such a navigation function is realized in such a manner that when a vehicle moves, the vehicle's present position and route information can be provided. It has also been attempted to develop a navigation for a pedestrian visiting a destination in a complicated downtown or a strange place, which uses a mobile communication terminal such as cellular phones, smart phones, and Personal Digital Assistants (PDAs). A navigation apparatus for pedestrians provides an optimum route to a predetermined destination to a pedestrian carrying the apparatus and allows the pedestrian to monitor a present position.

In a case of a conventional navigation using GPS, there was a problem in that when a pedestrian goes into a building or underground, he may not be able to receive a GPS signal and cannot use a navigation service. As a countermeasure for this, research on an indoor positioning technology has been conducted, in which an Access Point (AP) is provided within a building and a navigation system is realized indoors by using an RF signal. Besides the RF signal, infrared rays or ultrasonic waves may also be used.

An RF signal-based indoor positioning technology finds a position through a relative Received Signal Strength Indicator (RSSI) from a previously provided AP. An infrared ray-based indoor positioning technology finds a position by recognizing an infrared ray apparatus having a characteristic ID code by sensors attached in spots indoors. An ultrasonic wave-based indoor positioning technology finds a position of an object by using a transmission velocity difference between a high-speed RF signal and a relatively slow ultrasonic wave.

However, there is a disadvantage in that the indoor positioning technologies, except for the ultrasonic wave-based indoor positioning technology, generally not only show a large measurement error, but also require a large number of APs or infrared sensors. Also, an error in position information measurement is large (several meters or more), causing many inconvenient problems during the use.

In the case of an indoor positioning technology using an RF signal, it is difficult to exactly find a present position of a user because it is difficult to transmit an RF signal between walls. Also, in many cases, it is difficult to find an exact position between floors. The infrared ray-based indoor positioning technology has a problem in that it provides a limited service due to infrared rays' basic limitation in receiving range, and requires a very high cost for providing and maintaining a system. Also, the ultrasonic wave-based indoor positioning technology has a problem in that it requires a very high cost for providing the system while it can perform precise measurement.

### SUMMARY OF THE INVENTION

The present invention has been made to address at least the above problems and/or disadvantages and to provide at least the advantages described below. Accordingly, an aspect of the present invention provides a system for providing an indoor positioning service by using LED lighting, and at the same time, performing modulation/demodulation to maintain uniform brightness of the lighting by an asynchronous serial communication of positioning information data.

According to an aspect of the present invention, an LED lighting unit for performing indoor positioning is provided. The LED lighting unit includes a frame generating unit for generating at least one field constituting a frame and storing information of the LED lighting unit and transmission packet data in the at least one field. The LED lighting also includes a scrambler for modulating the transmission packet data in accordance with a predetermined method in order to maintain a uniform brightness of the LED lighting unit. The LED lighting unit further includes a positioning transmitter for transmitting the frame to at least one mobile terminal positioned within a light emitting range of the LED lighting unit, via visible light communication.

According to another aspect of the present invention, a mobile terminal is provided for performing indoor positioning using an LED lighting unit. The mobile terminal includes a positioning receiver for receiving a frame including information of the LED lighting unit and modulated transmission packet data, from the LED lighting unit via visible light communication. The mobile terminal also includes a descrambler for demodulating the modulated transmission packet data in accordance with a predetermined method in order to determine the modulated transmission packet data. The mobile terminal further includes a frame extracting unit for extracting the information included in the received frame.

According to a further aspect of the present invention, a method is provided for transmitting indoor positioning information by using an LED lighting unit. The LED lighting unit determines whether transmission packet data exists in a frame to be transmitted to at least one mobile terminal positioned within a light emitting range of the LED lighting unit. The transmission packet data is modulated in accordance with a predetermined method in order to maintain a uniform brightness of the LED lighting unit when the transmission packet data exists. The frame including the modulated transmission packet data is transmitted to the at least one mobile terminal.

According to an additional aspect of the present invention, a method is provided for receiving indoor positioning information using a mobile terminal. A frame including information of an LED lighting unit and modulated transmission packet data, is received by the mobile terminal via visible light communication from the LED lighting unit. The modulated transmission packet data included in the frame received from the LED lighting unit is demodulated in accordance with a predetermined method in order to determine the modulated transmission packet data. Indoor positioning is performed by using the demodulated transmission packet data and the information.

According to another aspect of the present invention, a system for performing indoor positioning using an LED lighting unit is provided. The system includes the LED lighting unit for determining whether transmission packet data exists in a frame to be transmitted, modulating the transmission packet data in order to maintain a uniform brightness of the LED lighting unit when the transmission packet data exists, and transmitting the frame comprising the modulated transmission packet data. The system also includes a mobile terminal for receiving the frame, demodulating the modulated transmission packet data to determine the transmission packet data, and performing indoor positioning by using the demodulated transmission packet data and information included in the frame.

### BRIEF DESCRIPTION OF THE DRAWINGS

The above and other aspects, features and advantages of the present invention will be more apparent from the following detailed description when taken in conjunction with the accompanying drawings, in which:

FIG. 1 is a diagram illustrating the configuration of an indoor positioning system, according to an embodiment of the present invention;

FIG. 2 is a block diagram illustrating a frame structure, according to an embodiment of the present invention;

FIG. 3 is a flow chart illustrating a process of generating and modulating a frame, according to an embodiment of the present invention;

FIG. 4 is a flow chart illustrating a process of demodulating modulated transmission packet data, according to an embodiment of the present invention; and

FIGS. 5A and 5B show a process of demodulating modulated transmission packet data, according to an embodiment of the present invention.

### DETAILED DESCRIPTION OF THE EMBODIMENTS OF THE PRESENT INVENTION

Embodiments of the present invention are described in detail with reference to the accompanying drawings. The same or similar components may be designated by the same or similar reference numerals although they are illustrated in different drawings. Detailed descriptions of constructions or processes known in the art may be omitted to avoid obscuring the subject matter of the present invention.

In embodiments of the present invention, in order to provide a positioning service indoors, such as large buildings or large underground shopping centers, visible light communication through LED lighting is used to perform a function of lighting, and at the same time, to transmit an ID and data to be transferred to a mobile terminal. Since each LED lighting unit fixed at a corresponding position has characteristic identification (ID) information a mobile terminal can determine its present position by receiving ID information from a specific LED lighting unit. Hereinafter, an indoor positioning system of embodiments of the present invention will be described in detail with reference to the accompanying drawings.

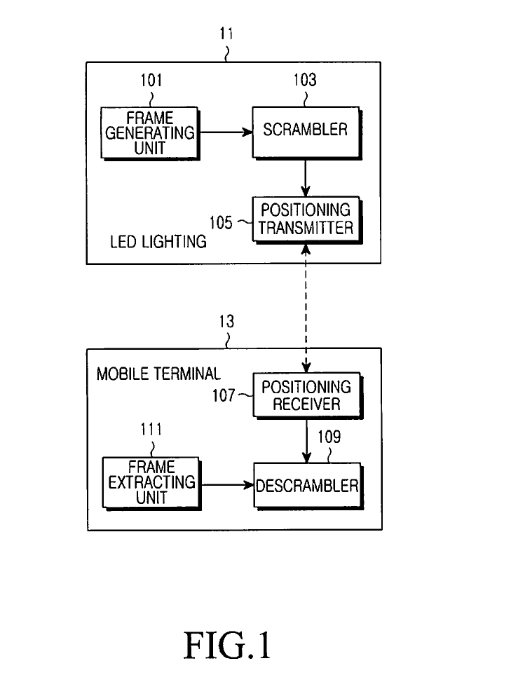

FIG. 1 is a diagram illustrating the configuration of an indoor positioning system, according to an embodiment of the present invention. The indoor positioning system includes an LED lighting unit 11 and a mobile terminal 13. The LED lighting unit 11 includes a frame generating unit 101, a scrambler 103, and a positioning transmitter 105. The mobile terminal 13 includes a positioning receiver 107, a descrambler 109, and a frame extracting unit 111.

Referring to FIG. 1, the LED lighting unit 11 transmits a characteristic ID and data to be transferred while also being a lighting lamp. The data to be transferred may be information on indoor positioning such as indoor map information, or information required for a user. Such data may be stored in the LED lighting unit 11, or may be connected to a wired network and received from a server controlling the wired network, which will be described in greater detail below.

The frame generating unit 101 included in the LED lighting unit 11 generates a frame including the LED lighting unit's 11 characteristic ID and data.

The scrambler 103 modulates codes constituting transmission packet data to be included in the generated frame, specifically, a binary combination (0 and 1) in such a manner that the binaries are uniformly distributed so as to maintain uniform brightness of the LED lighting 11. The combination of 0 and 1 is modulated to be uniform so that when the amount of transmission packet data besides ID is large, the brightness of the LED lighting unit 11 is uniformly maintained when a time for transmitting the transmission packet data is prolonged.

The positioning transmitter 105 transmits the frame including the transmission packet data modulated by the scrambler 103, to the mobile terminal. When the transmission packet data is not included, a dummy bit is included instead and transmitted.

The mobile terminal 13 extracts the ID and the transmission packet data from the frame received from the LED lighting unit 11, determines its position, and obtains required information by analyzing the transmission packet data. Since the transmission packet data included in the frame received from the LED lighting unit 11 has been modulated by the scrambler 103, a device for demodulating is required. The internal configuration of the mobile terminal 13 is described in detail below.

The positioning receiver 107 included in the mobile terminal 13 receives the frame transmitted from the positioning transmitter 105 of the LED lighting unit 11.

The descrambler 109 sequentially decomposes and demodulates the transmission packet data into the binary combination constituting the original transmission packet data in such a manner that the transmission packet data included in the received frame can be analyzed. In the demodulation, an exclusive OR (XOR) operation is performed between the transmission packet data and another transmission packet data shifted by 1 bit with respect to the transmission packet data to the right, and the result is divided by 2 bits. When 1 exists within the divided one or more groups, the state of received bits of a previous group is changed. When 1 does not exist within the group, the original state is maintained. This demodulates the received frame into the original frame.

The frame extracting unit 111 determines the LED lighting unit's 11 characteristic ID and its data by extracting various information within the frame. The determined characteristic ID and data are used to obtain the mobile terminal's 13 present position and additional information. The various information may also be selectively displayed on a display unit of the mobile terminal so that the user of the mobile terminal can know the information.

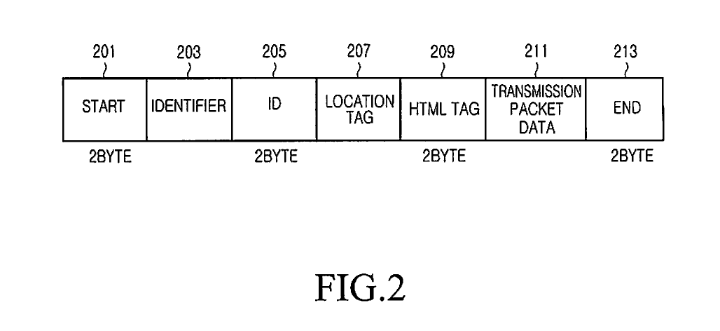

FIG. 2 is a block diagram illustrating a frame structure, according to an embodiment of the present invention. The frame structure of an embodiment of the present invention includes other configurations besides packet data indicating the LED lighting unit's 11 characteristic ID and data.

Referring to FIG. 2, start and end fields 201 and 213 perform the start and the end of an asynchronous serial communication, respectively. An identifier field 203 determines if additional transmission packet data, besides the positioning ID information, is included in the frame. According to the inclusion or lack of inclusion of the transmission packet data, it is determined whether to insert a dummy bit or not. An ID field 205 includes the LED lighting unit's 11 characteristic position information linked with map information. One or more LED lighting units included in a specific group indoors have to transmit their IDs themselves. Thus, when an LED lighting unit is initially provided indoors, a new ID is assigned during a design process, and an ID once assigned and provided to an LED lighting unit is not changed.

A location tag field 207 is used as a field for providing information of an approximate floor and an area where the LED lighting unit 11 is positioned in the form of text (e.g.,: 3FA8). An HTML tag field 209 is used as a field for providing URL information to be linked with an Internet network through the mobile terminal 13 so as to provide additional information. A packet data field 211 stores data to be additionally transmitted as additional transmission packet data for providing an additional LBS service. When there is no transmission packet data to be additionally transmitted, a dummy bit replaces it. Hereinafter, a process for modulating a frame will be described with reference to the configuration view shown in FIG. 2.

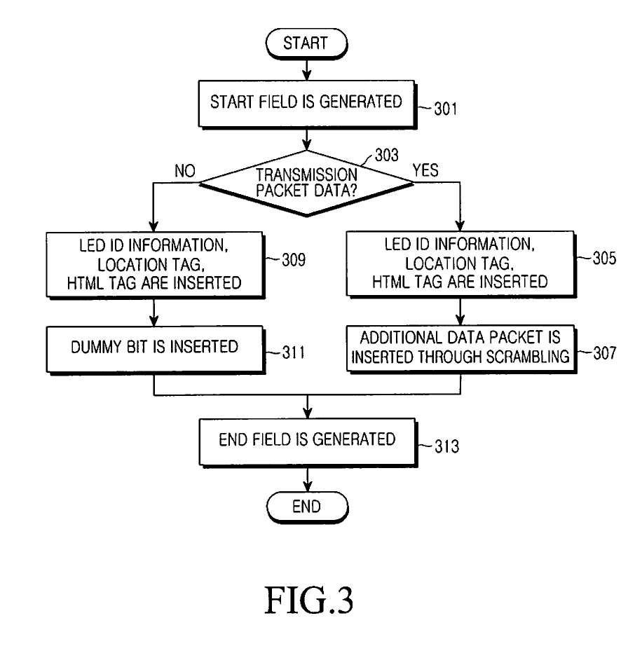

FIG. 3 is a flow chart illustrating a process of generating and modulating a frame, according to an embodiment of the present invention.

Referring to FIG. 3, in step 301, the start field 201 is generated. The generated start field 201 includes information indicating the start of the asynchronous serial communication. In step 303, the identifier field 203 is generated to determine if additional transmission packet data exists or not. If there is no additional transmission packet data, the value included in the identifier field 203 is set as 0, and is stored. The process then proceeds to step 309. In step 309, the ID field 205 is generated, and the LED lighting unit's 11 ID information, which is characteristic position information linked with map information, is sequentially stored. The location tag field 207 and the HTML field 209 are also generated to respectively store the LED lighting unit's 11 position information and URL information to be linked with an Internet network. The process then proceeds to step 311 to generate the packet data field 211. However, since there is no additional transmission packet data, a dummy bit is inserted into an empty space without a scrambling process. The dummy bit is inserted with a pattern of “01010101 . . . ” or “10101010 . . . ”. In step 313, the end field 213 is generated to store information indicating the end of the asynchronous serial communication.

If there is additional transmission packet data in step 303, the value included in the identifier field 203 is set as 1, and stored. The process then proceeds to step 305. In step 305, the ID field 205 is generated, and the LED lighting unit's 11 ID information is sequentially stored. The location tag field 207 and the HTML field 209 are also generated to respectively store the LED lighting unit's 11 position information and URL information to be linked with an Internet network. The process then proceeds to step 307 to generate the transmission packet data field 211. Since it has determined that there exists additional transmission packet data in the identifier field 203, the transmission packet data is stored in the generated packet data field 211. if the data is simply stored, the brightness of the LED lighting 11 may be changed according to the amount of packet data. Thus, in order to maintain uniform brightness of the LED lighting 11, the scrambler 103 is used to modulate a code constituting the transmission packet data. Then, in step 313, the end field 313 is generated to store information indicating the end of the asynchronous serial communication.

In the method for modulating a code constituting the transmission packet data in order to maintain uniform brightness of the LED lighting unit 11 through the scrambler 103, the modulation is performed by Equation (1) below.

Xₙ→X₂ₙ₋₁, X̅ₙ̅→X₂ₙ

n=1, 2, 3 . . .

00001111→0101010110101010

01101001→0110100110010110 (1)

In Equation (1), when the transmission packet data to be transmitted is Xn, Xn is doubled to make 0 and 1 of the packet have the same length. In other words, 2Xn has a length twice as long as original transmission packet data. Xn is transmitted in an odd bit, and the value corresponding to NOT of Xn is obtained and transmitted in an even bit. Then, the length of the packet is doubled, but a pattern in which 0 and 1 are always repeated is generated. In other words, although the capacity of transmission packet data to be transmitted is reduced by half, 0 and 1 can always transmit uniform transmission packet data. Thus, the brightness of the LED lighting can be uniform, and temporary flickering of the LED lighting can be inhibited.

Equation (1) shows, as one example, the result of modulation of “00001111” and “01101001” in accordance with the above described mechanism. “00001111” was modulated into “0101010110101010”, and “01101001” was modulated into “0110100110010110”. From this, it can be found that the capacity was doubled, and 0 and 1 were uniformly modulated. A process for demodulating the modulated transmission packet data by the predetermined method is described in detail below.

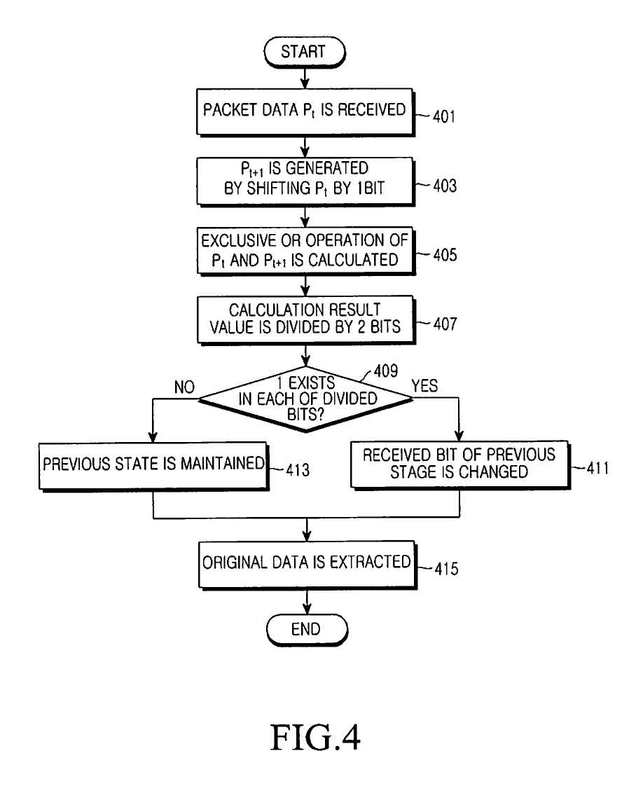

FIG. 4 is a flow chart illustrating a process of demodulating the modulated transmission packet data, according to an embodiment of the present invention. The transmission packet data received from the LED lighting unit 11 is demodulated through the descrambler 109 of the mobile terminal 13.

Referring to FIG. 4, in step 401, the mobile terminal 13 receives the transmission packet data modulated by the scrambler 103, from the LED lighting unit 11. The received transmission packet data is transmitted to the descrambler 109 via the positioning receiver 107 of the mobile terminal 13. In step 403, the descrambler 109 generates a code constituting another transmission packet data shifted by 1, bit, with respect to the received transmission packet data, to the right by using a code constituting the transmission packet data. The code constituting the first received transmission packet data is set as Pt, and the code constituting the transmission packet data shifted to the right by 1 bit is set as Pt+1. In step 405, an exclusive OR operation between Pt and Pt+1 is calculated. The calculated value is sequentially divided by 2 bits in step 407. In step 409, it is determined if 1 exists in each of the sequentially divided groups. If 1 exists, the process proceeds to step 411, and the state of received bits of a previous group is changed. If 1 does not exist within the groups, the process proceeds to step 413, and the original state is maintained. When step 411 or 413 is completed, it is possible to obtain a code constituting the transmission packet data before modulation, in step 415.

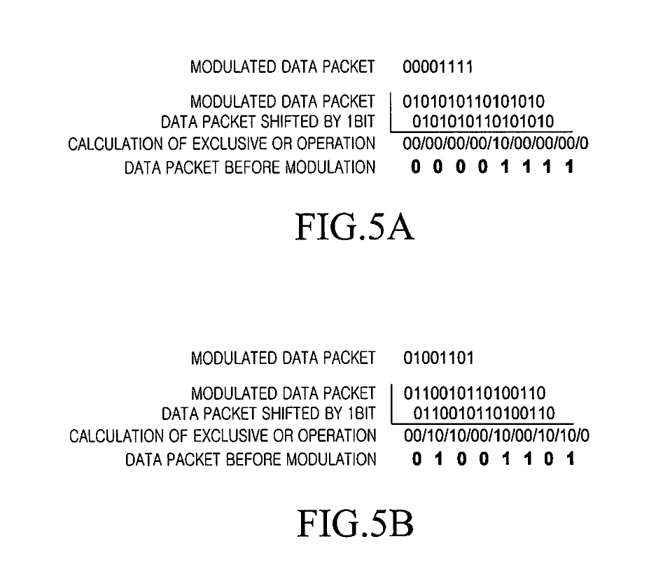

FIGS. 5A and 5B is show a process of demodulating modulated transmission packet data, according to an embodiment of the present invention.

Referring to FIG. 5A, when a code constituting transmission packet data before modulation is “00001111”, a code (Pt) constituting modulated transmission packet data is “0101010110101010”, and a code (Pt+1) constituting transmission packet data shifted to the right by 1 bit is “0101010110101010”. An exclusive OR operation between Pt and Pt+1 is calculated, and the calculated value is divided by 2 bits. When 1 exists within each of the divided groups, the state of received bits of a previous group is changed. When 1 does not exist within the groups, the original state is maintained. Through this process, transmission packet data before modulation is extracted.

From FIG. 5A, it can be shown that the result value of the exclusive OR operation is “00000000100000000”, and the result obtained by dividing this by 2 bits is “00/00/00/00/10/00/00/00/0”. It can then be found that after the state of received bits is changed according to existence or non-existence of 1 within each of divided groups, the code constituting the transmission packet data before modulation, that is, “00001111”, is obtained.

FIG. 5B, shows the same process as that in FIG. 5A, in which the exclusive OR operation is calculated, the result is divided by 2 bits, the state of received bits of a previous group is changed when 1 exists within each of divided groups, and the original state is maintained when 1 does not exist within each group.

In embodiments of the present invention, the brightness of an LED lighting unit can be uniformly maintained through scrambling and descrambling, thereby providing various information as well as positioning information. This improves convenience of use for a user.

While the invention has been shown and described with reference to certain embodiments thereof, it will be understood by those skilled in the art that various changes in form and detail may be made therein without departing from the spirit and scope of the invention as defined by the appended claims.

What is claimed is:

1. A Light Emitting Diode (LED) lighting unit for performing indoor positioning, the LED lighting unit comprising:
a frame generating unit for generating at least one field constituting a frame and storing information of the LED lighting unit and transmission packet data in the at least one field;
a scrambler for modulating the transmission packet data in accordance with a predetermined method in order to maintain a uniform brightness of the LED lighting unit; and
a positioning transmitter for transmitting the frame to at least one mobile terminal positioned within a light emitting range of the LED lighting unit, via visible light communication.

2. The LED lighting unit as claimed in claim 1, wherein the frame comprises:
start and end fields respectively comprising information indicating a start and an end of an asynchronous serial communication;
an identifier field comprising information for determining whether the transmission packet data exists in the frame;
an ID field comprising characteristic ID information of the LED lighting unit;
a location tag field comprising information on a position of the LED lighting unit;
a Hyper Text Markup Language (HTML) tag field comprising Uniform Resource Locator (URL) information for providing additional information; and
a packet data field comprising the transmission packet data.

3. The LED lighting unit as claimed in claim 2, wherein the packet data field comprises a dummy bit instead of the transmission packet data when the transmission packet data is not included.

4. The LED lighting unit as claimed in claim 1, wherein the scrambler modulates the transmission packet data to maintain the uniform brightness of the LED lighting unit in such a manner that a binary combination of 0 and 1 constituting the transmission packet data is uniformly distributed.

5. A mobile terminal for performing indoor positioning using a Light Emitting Diode (LED) lighting unit, the mobile terminal comprising:
a positioning receiver for receiving a frame comprising the LED lighting unit's information and modulated transmission packet data, from the LED lighting unit via visible light communication;
a descrambler for demodulating the modulated transmission packet data in accordance with a predetermined method in order to determine the modulated transmission packet data; and
a frame extracting unit for extracting the information included in the received frame.

6. The mobile terminal as claimed in claim 5, wherein the descrambler generates transmission packet data shifted by 1 bit with respect to the modulated transmission packet data by using binary numbers constituting the modulated transmission packet data included in the frame, calculates an exclusive OR operation between the modulated transmission packet data and the transmission packet data shifted by 1 bit, divides a calculation result value by 2 bits into one or more groups, changes a state of a received bit in a previous group when a 1 exists within each of the groups, and maintains a present state when a 1 does not exist within each of the groups, so as to obtain demodulated transmission packet data.

7. The mobile terminal as claimed in claim 5, wherein the frame extracting unit extracts information on an ID and a position of the LED lighting unit, and Uniform Resource Locator (URL) information for providing additional information, included in the frame, and displays the extracted information on a display unit of the mobile terminal.

8. A method for transmitting indoor positioning information by using a Light Emitting Diode (LED) lighting unit, the method comprising the steps of:
determining whether transmission packet data exists in a frame to be transmitted to at least one mobile terminal positioned within a light emitting range of the LED lighting unit, by the LED lighting unit;
modulating the transmission packet data in accordance with a predetermined method in order to maintain a uniform brightness of the LED lighting unit when the transmission packet data exists; and
transmitting the frame comprising the modulated transmission packet data to the at least one mobile terminal.

9. The method as claimed in claim 8, wherein when the modulated transmission packet data does not exist, a dummy bit having no information, is inserted into the frame instead of the modulated transmission packet data, and is transmitted to the at least one mobile terminal.

10. The method as claimed in claim 8, wherein the frame comprises information indicating a start and an end of an asynchronous serial communication, information indicating existence or non-existence of the transmission packet data, characteristic ID information of the LED lighting unit linked with map information, position information of the LED lighting unit, and Uniform Resource Locator (URL) information for providing additional information.

11. The method as claimed in claim 10, wherein the position information of the LED lighting unit provides information on a floor and an area where the LED lighting unit is positioned, in a text form.

12. The method as claimed in claim 8, wherein, in modulating the transmission packet data in accordance with the predetermined method, in order to maintain the uniform brightness of the LED lighting unit, the transmission packet data is modulated in such a manner that a binary combination of 0 and 1 constituting the transmission packet data is uniformly distributed.

13. A method for receiving indoor positioning information by using a mobile terminal, the method comprising the steps of:
receiving a frame comprising information of a Light Emitting Diode (LED) lighting unit and modulated transmission packet data, via visible light communication from the LED lighting unit, by the mobile terminal;
demodulating the modulated transmission packet data included in the frame received from the LED lighting unit, in accordance with a predetermined method in order to determine the modulated transmission packet data; and
performing indoor positioning by using the demodulated transmission packet data, and the information.

14. The method as claimed in claim 13, wherein the step of demodulating the modulated transmission packet data comprises:
generating transmission packet data shifted by 1 bit with respect to the modulated transmission packet data by using the modulated transmission packet data included in the frame;
calculating an exclusive OR operation between the modulated transmission packet data and the transmission packet data shifted by 1 bit; and
dividing a calculation result value by 2 bits into one or more groups, changing a state of a received bit in a previous group when a 1 exists within each of the groups, and maintaining a present state when a 1 does not exist within each of the groups, so as to obtain demodulated transmission packet data.

15. The method as claimed in claim 13, wherein the frame comprises a dummy bit having no information, instead of the modulated transmission packet data.

16. A system for performing indoor positioning using a Light Emitting Diode (LED) lighting unit, the system comprising:
the LED lighting unit for determining whether transmission packet data exists in a frame to be transmitted, modulating the transmission packet data in order to maintain a uniform brightness of the LED lighting unit when the transmission packet data exists, and transmitting the frame comprising the modulated transmission packet data; and
a mobile terminal for receiving the frame, demodulating the modulated transmission packet data to determine the transmission packet data, and performing indoor positioning by using the demodulated transmission packet data and information included in the frame.
